(19) United States
(12) Patent Application Publication
(10) Pub. No.: US 2009/0102980 A1
(43) Pub. Date: Apr. 23, 2009

(54) TUNER

(76) Inventors: Cho-chun Huang, HsinChu city (TW); I-Hao Pao, HsinChu city (TW)

Correspondence Address: SINORICA, LLC, 528 FALLSGROVE DRIVE, ROCKVILLE, MD, 20850, US

(21) Appl. No.: 12/198,926

(22) Filed: Aug. 27, 2008

(30) Foreign Application Priority Data
Oct. 18, 2007 (TW) 096138966

(51) Int. Cl. H04N 5/63

(52) U.S. Cl. 348/730

(57) ABSTRACT

A tuner at least comprises a filter, a low noise amplifier, a mixer, a local oscillator, a frequency selector and a power management module, and the tuner is characterized in that the power management module includes a power detection means which has a first terminal connected to an input terminal of the tuner for detecting the power level of the input terminal and a second terminal connected to the low noise amplifier, and a power management means which has a first terminal connected to a third terminal of the power detection means for reducing the power consumption of the tuner by means of the power management module which makes the tuner operative under the optimum condition for power consumption.

### BACKGROUND OF THE INVENTION

1. Field of the Invention

The present invention is related to a tuner, more particularly, is related to a tuner including a power manage module and the tuner uses the power manage module to detect the power level of the input power and control the power consumption and performance of the tuner according to the value of the power level.

2. Description of the Prior Art

Because the improvement of the communicative and the depressive technique, the global television broadcast system is switched from analog to digital. The change of the digital TV broadcast will trigger the high development of the relative industry, such as Set-Top-Box (STB) or high definition television (HDTV). In future, the digital TV broadcast will go mobile and the TV shows will be available at anytime and anywhere. Therefore, the tuner circuit in the STB and HDTV is a key issue in the industry.

FIG. 1A is a view of a conventional tuner included single conversion with intermediate frequency (IF). As shown in FIG. 1A, the tuner 100 includes a filter 101, a low noise amplifier 102 (LNA), a mixer 106, a local oscillator 110 and a filter 112. The filter 101 and the filter 112 are SAW filter. The radio frequency (RF) (such as frequency within 50˜860 MHz) received by the antenna (not shown) of the tuner 100 is transmitted from the filter 101 to the LNA 102 to be amplified. Then, the mixer 106 and the local oscillator 110 are used to decrease the amplified radio frequency to be the frequency within the intermediate frequency range, such as 36 MHz. The filter 112 is used to select the suitable channel.

FIG. 1B is a view of a conventional tuner included dual conversion with IF. As shown in FIG. 1B, the tuner 100 includes a low noise amplifier 102 (LNA), an IF/RF mixer 106a, a band-pass filter 104, an IF/IF mixer 106b, and a filter 112. One end of the low noise amplifier 102 is connected the antenna and the low noise amplifier 102 amplifiers the radio frequency. Then, the mixer 106a and the local oscillator 110A are used to increase the amplified radio frequency to be the frequency within the intermediate frequency range, such as 1 GHz. One end of the mixer 106a is connected to the output end of the low noise amplifier. The local oscillator 110A is connected to another end of the mixer 106a and used to provide a frequency of the local oscillator, such as 1 GHz˜2 GHz. Then, the input end of the band-pass filer 104 is connected to the output end of the mixer 106a and used to filer the noise and output the intermediate frequency from another end. The mixer 106b and the local oscillator 110B are used to decrease the first intermediate frequency to be the second intermediate frequency. The filter 112 is used to select the suitable channel. Moreover, the filter 112 can be a channel select filter that used to select a desired channel and filter other unwanted channels. Obviously, the tuner with the dual conversion with IF is able to filter the mirror signals without using a lot of filters.

FIG. 1C is a view of a conventional tuner including a dual conversion with low IF. As shown in FIG. 1C, the radio frequency is transmitted into the low noise amplifier 102 to be amplified and divided into I Path and Q Path by a RF poly-phase filter. Then the frequency is transmitted into the complex mixer (also called dual quadrature mixer). The complex mixer 114 is made by a plurality of mixers 106. The quadrature local oscillator 111 will transmit the oscillated frequency to the complex mixer 114 to be mixed into I Path and Q Path quadrature low IF. The quadrature local oscillator 111 is generated by the local oscillator 111 and a divider 110 (such as divided by 2). Another IF poly-phase filter 113 will transform the I Path and Q Path low IF quadrature signal to be the I Path and Q Path low IF signal to decrease the frequency and filter the mirror frequency. At final, the channel select filter is used to select the desired channel and filter other unwanted channels. Therefore, the function of the tuner is completed.

FIG. 1D is a view of a conventional tuner including dual conversion with low IF. As shown in FIG. 1D, the radio frequency is transmitted into the low noise amplifier 102 to be amplified, and increased the frequency to be IF and mixed into in-phase frequency 1 (IIF1) and quadrature phase by a first quadrature mixer 120 and a first quadrature LO 117. Then the frequency is mixed into quadrature low IF of the IIF1 and the QIF1 by the complex mixer 122 and the second quadrature LO 119. The IF poly-phase filter 118 is used to transform the quadrature low IF signals of the IIF1 and the QIF1 into low IF signals to decrease the frequency and filter the mirror frequency. The channel select filter 116 is used to select the desired channel and filter other unwanted channels. Therefore, the function of the tuner is completed.

In each of the tuner described above, when the strength of the radio frequency is changed, such as the user end is far away from the transmitted station, the radio signal transmitted to the user end is extremely weak. The low noise amplifier is necessary to be adjusted in the maximum gain to amplify the weak signals. When the user end is closed to the transmitted station, the radio signal transmitted to the user end is extremely weak. The low noise amplifier is necessary to be adjusted in the minimum gain to avoid the signal saturation. Therefore, a new circuit structure used to detect the power level of the radio frequency in the tuner is disclosed in the present invention and the gain and the current of the low noise amplifier is able to adjust. The tuner can work at the better power consumption with better performance.

### SUMMARY OF THE INVENTION

According to the background of the invention described above, in order to satisfy the requirement of the industry, the main object of the present invention is to provide a tuner structure and the tuner is able to work at the optimum power consumption to decrease the power consumption of the tuner.

Another object of the present invention is to provide a tuner structure and the tuner is able to work at the optimum consumption and the best performance condition.

One another object of the present invention is to provide a frequency inversion device and the frequency inversion device is able to work at the optimum power consumption to decrease the power consumption of the tuner.

One another object of the present invention is to provide a frequency inversion device and the frequency inversion device is able to at the optimum consumption and the best performance condition.

A frequency conversion device comprising at least one low noise amplifier, a mixer, a local oscillator and a power manage module is characterized at: the power manage module comprising a power detector and a first end of the power detector is connected to the input end of the frequency conversion device and used to detect the power level of the input end, and the second end is connected to the low noise amplifier; and a power manage device and a first end of the power manage device is connected to the low noise amplifier.

A dual frequency conversion device comprising a serial connection of a first single frequency conversion device and a second single frequency conversion device and the first single frequency conversion device and the second single frequency conversion device includes a low noise amplifier, a mixer, an oscillator and a power manage module and is characterized by the power manage module comprising: a power detector and a first end of the power detector is connected to the input end of the frequency conversion device and used to detect the power level of the input end, and the second end is connected to the low noise amplifier; and a power manage device and a first end of the power manage device is connected to the low noise amplifier.

A tuner comprising a filter, a low noise amplifier, a mixer, a local oscillator, a frequency selector and a power manage module is characterized by the power manage module comprising: a power detector and a first end of the power detector is connected to the input end of the frequency conversion device and used to detect the power level of the input end, and the second end is connected to the low noise amplifier; and a power manage device and a first end of the power manage device is connected to the low noise amplifier.

A tuner comprising a poly-phase filter, a low noise amplifier, a complex mixer, a quadrature local oscillator, a frequency selector and a power manage module is characterized by the power manage module comprising: a power detector and a first end of the power detector is connected to the input end of the frequency conversion device and used to detect the power level of the input end, and the second end is connected to the low noise amplifier; and a power manage device and a first end of the power manage device is connected to the low noise amplifier.

A tuner comprising a serial connection of a first single frequency conversion device and a second single frequency conversion device, a filter, a low noise amplifier, and the first single frequency conversion device includes a mixer, a local oscillator, a frequency selector and a power manage module and the second single frequency conversion device includes a mixer, a local oscillator, a frequency selector and a power manage module and is characterized by the power manage module of the first single frequency conversion device comprising: a power detector and a first end of the power detector is connected to the input end of the frequency conversion device and used to detect the power level of the input end, and the second end is connected to the low noise amplifier; a power manage device and a first end of the power manage device is connected to the low noise amplifier; and the power manage module of the second single frequency conversion device comprising: a power detector and a first end of the power detector is connected to the input end of the frequency conversion device and used to detect the power level of the input end, and the second end is connected to the low noise amplifier; and a power manage device and a first end of the power manage device is connected to the low noise amplifier.

A tuner comprising a serial connection of a first single frequency conversion device and a second single frequency conversion device, and the first single frequency conversion device includes a filter, a low noise amplifier, a mixer, a local oscillator, a frequency selector and a power manage module and the second single frequency conversion device includes a mixer, a local oscillator, a frequency selector and a power manage module and is characterized by: the power manage module comprising: a power detector and a first end of the power detector is connected to the input end of the frequency conversion device and used to detect the power level of the input end, and the second end is connected to the low noise amplifier; and a power manage device and a first end of the power manage device is connected to the low noise amplifier.

An adjust method of a tuner, comprising: providing a tuner and the tuner includes a filter, a low noise amplifier, a mixer, a local oscillator, a frequency selector and a power manage module; executing a power detecting to receive a radio frequency of the tuner and detect a power level of the radio frequency by an input end of a power detector; executing a power programming to determine the power level and output a controlled signal by a power manage device; and executing a power adjusting to adjust the gain of the low noise amplifier by the controlled signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a view of a conventional tuner included single conversion with IF;

FIG. 1B is a view of a conventional tuner included dual conversion with IF;

FIG. 1C is a view of a conventional tuner included dual conversion with low IF;

FIG. 1D is a view of a conventional tuner including dual conversion with low IF;

FIG. 2 is a view showing a tuner with power manage module in the present invention;

FIG. 3 is a view showing a tuner with power manage module in another embodiment of the present invention;

FIG. 4 is a view showing a tuner with power manage module in another embodiment of the present invention;

FIG. 5 is a view showing a dual frequency conversion device with power manage module in the present invention;

FIGS. 6A˜6B are views showing the low noise amplifier in the present invention;

FIGS. 7A˜7B are views showing the low noise amplifier in another embodiment of the present invention; and

FIG. 8 is a view showing the low noise amplifier in one another embodiment of the present invention.

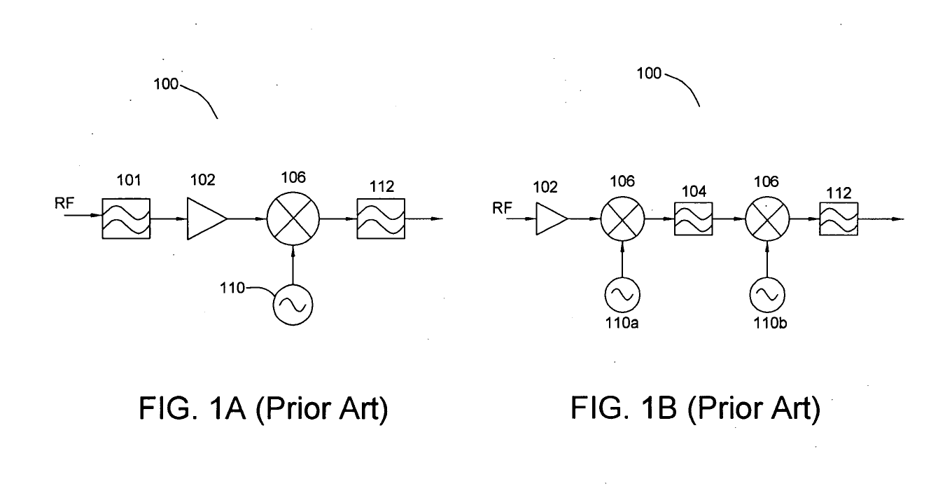

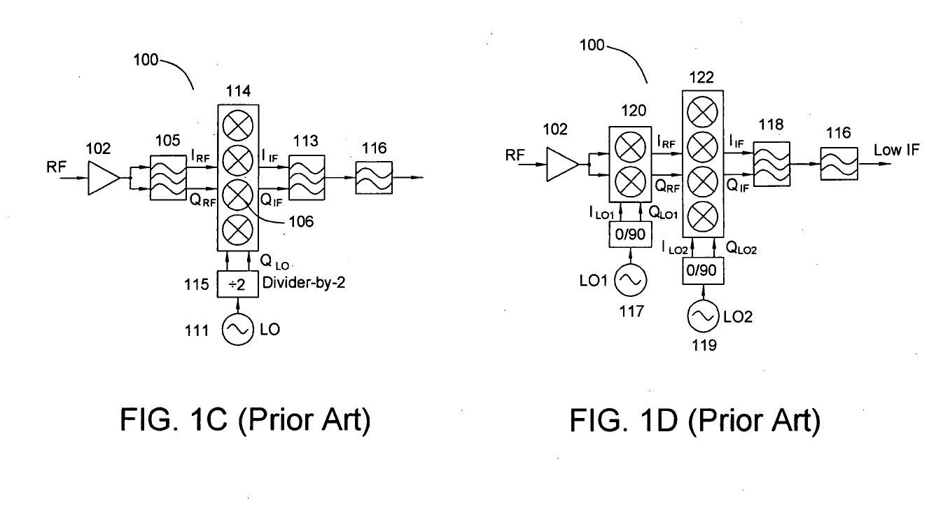

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

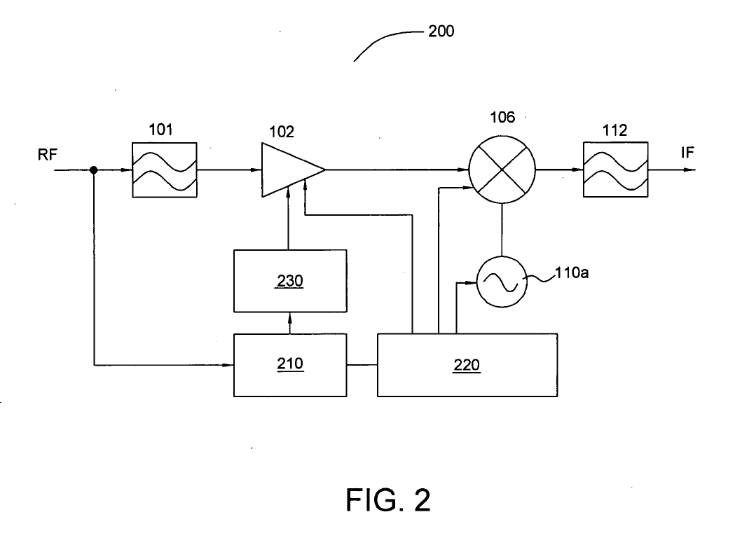

FIG. 2 is a view showing a tuner with single conversion with IF. The tuner is an over heterodyne tuner or a broadband tuner, such as digital TV tuner. As shown in FIG. 2, the tuner 200 includes a filter 101, a low noise amplifier (LNA) 102, a mixer 106, a filter 112, and a power manage module 210. The power manage module includes a power detector 210 and a power manage device 220. The filter 101 and the filter 112 are SAW filters.

As shown in FIG. 2, the antenna (not shown) of the tuner will receive the radio frequency (frequency between 50˜860 MHz) and transmit the frequency to the low noise amplifier 102 after passing the filter 101. The power detector 210 will detect the RF power level at the same time and transmit the power level value to the power manage device. For example, the power manage 220 is a power/current mode controller. In other words, the power detector 210 will transmit the power level to the low noise amplifier 102 to adjust the power operation of the low noise amplifier 102.

Still referring to FIG. 2, when the power manage device 220 receives the power level, it will determine the value of the power level. When the power level is a large signal, such as over 50 dbm, the power manage device 220 will set the tuner in the maximum current mode control condition and transmitting a current controlled signal to the low noise amplifier 102, such as sending a minimum gain of the current controlling signal. Besides, in the preferred embodiment of the present invention, there is an automatic gain controlled circuit 230 disposed between the power detector 210 and the low noise amplifier 102. The power detector 210 will transmit the power level to the automatic gain controlled circuit 230 first and then the automatic gain controlled circuit 230 will transmit the signal to the low noise amplifier 102. Therefore, the low noise amplifier 102 can be operated in better power operation mode. In addition, the power manage device 220 is also able to connect with low noise amplifier 102, the mixer 106 and any other components (not shown), as shown in FIG. 2. Therefore, when the power manage device 220 received the power level detected by the power detector 210, the power manage device will adjust the current of the low noise amplifier 102 and/or the mixer 106 in accordance with the current power level. And also other components will be adjusted by the power manage device 220 at the same time, and those components can work compatibly with the low noise amplifier 102. Moreover, in the same period, the power manage device 220 can control the current of the low noise amplifier 102 in accordance with the frequency of the local oscillator 110a to avoid the gain signal is big enough to be flowed to the mixer 106 or the local oscillator 110a. It would cause the problem of the frequency-shifted. Obviously, according to the operation of the power detector 210 and the power manage device 220 in the power manage module; the tuner 200 of the present invention can work in optimum power consumption and the optimum condition when the power level is too large.

When the input power level is a small signal, such as less than 10 dbm, the power manage device 220 will set the tuner in the minimum current mode control and output a current controlled signal, such as the largest gain of the current controlled signal, to the low noise amplifier 102. Similarly, in the preferred embodiment, there is an automatic gain controlled circuit 230 disposed between the power detector 210 and the low noise amplifier 102. The power detector 210 will transmit the power level to the automatic gain controlled circuit 230 first and then the automatic gain controlled circuit 230 will transmit the signal to the low noise amplifier 102. Therefore, the low noise amplifier 102 can be operated in better power operation mode. Similarly, the power manage device 220 is also able to connect with low noise amplifier 102, the mixer 106 and any other components (not shown). Therefore, when the power manage device 220 received the power level detected by the power detector 210, the power manage device 220 will adjust the current of the low noise amplifier 102 and/or the mixer 106 in accordance with the current power level. And also other components will be adjusted by the power manage device 220 at the same time, and those components can work compatibly with the low noise amplifier 102. Obviously, according to the operation of the power detector 210 and the power manage device 220 in the power manage module; the tuner 200 of the present invention can work in optimum power consumption and the optimum condition when the power level is small.

When the input power level is between 50 dbm and 10 dbm, such as 30 dbm, the power detector 210 won't change the gain of the low noise amplifier 102. The low noise amplifier 102 is operated in the normal standard mode, such as the gain is configured in a linear operative range. The power manage device 220 is able to adjust the current of the low noise amplifier 102 and/or mixer 106 in accordance with the current power level. And also other components will be adjusted by the power manage device 220 at the same time, and those components can work compatibly with the low noise amplifier 102. The tuner 200 of the present invention can work in optimum power consumption and the optimum condition.

As the description above, when the low noise amplifier 102 will amplify the radio frequency by a suitable gain in accordance with the controlled signal transmitted by the automatic gain controlled circuit 230. The amplified signal is divided into intermediate frequency, such as 36 Hz, by a mixer and a local oscillator 110a.

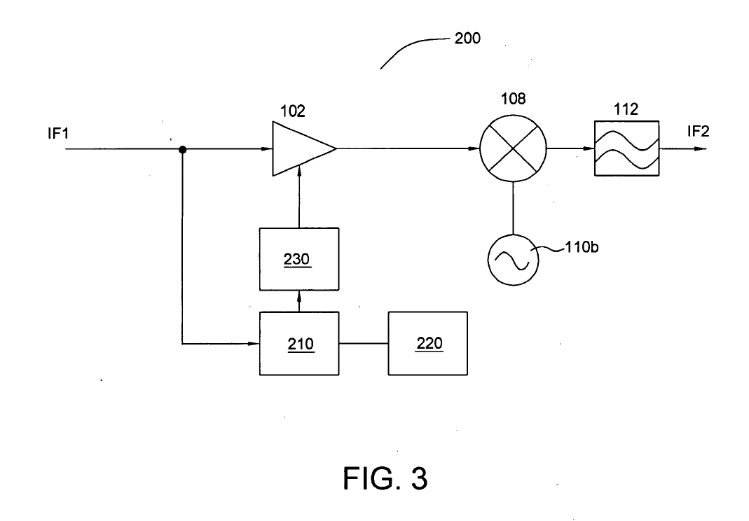

Besides, it should be noted that the power manage module of the present invention is able to be composed with the low noise amplifier 102, the mixer 106 and the local oscillator 10a to be a frequency conversion apparatus. As shown in FIG. 3, it can form an up-conversion device or a down-conversion device according to the high or low of the oscillated frequency of the local oscillator. At final, another filter 112 is used to filter some unwanted channel and the tune function of the tuner is accomplished.

The input signal is not just a radio frequency signal. For example, when the input is an intermediate frequency signal, the present embodiment is able to achieve the function described above. When the power manage module, the low noise amplifier 102, the mixer 106 and the local oscillator 110a are together formed a down-conversion device and are able to connect with the power detector 210 and the power manage device 220 of the power module. And there is also an automatic gain controlled device disposed between the power detector 210 and the low noise amplifier 230. Therefore, the frequency conversion device of the present invention can work in optimum power consumption and the optimum condition.

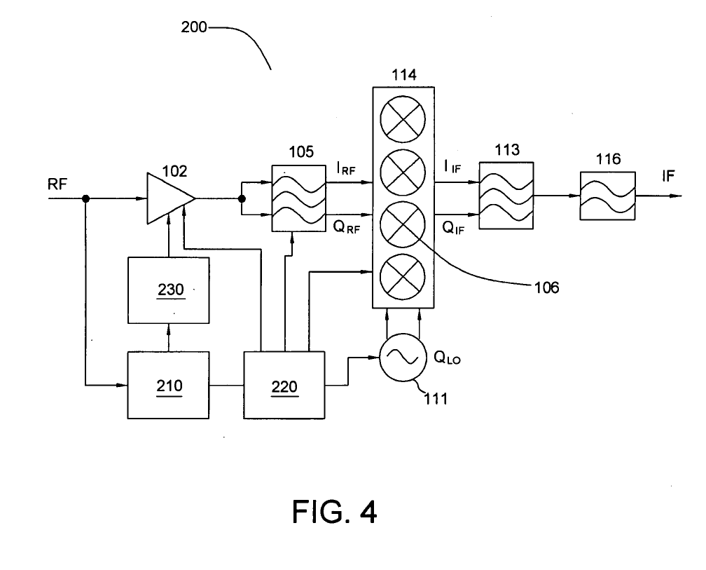

FIG. 4 is a view showing a single conversion tuner. The tuner 200 includes a low noise amplifier 102, a first poly-phase filter 105, a complex mixer 114, a quadrature local oscillator 111, a second poly-phase filter 113, a frequency selector 116 and a power manage module. And the power manage module includes a power detector 210 and a power manage device 220. As shown in FIG. 4, when the radio frequency is transmitted to the tuner, the power detector 210 will detect the power level of the input radio frequency. Then, the power level is transmitted to the power manage device 220, such as a power/current mode controlled device. In other words, the power detector 210 also will transmit the power level to the low noise amplifier 102 to adjust the power operation of the low noise amplifier 102. When the power mange device 220 receives the power level, it will determine the value of the power level. When the input power level is large, such as over than 50 dbm, the power manage device 220 will set the tuner in the maximum current control mode and send a current controlled signal to the low noise amplifier, such as sending a minimum gain of the current controlling signal. In the preferred embodiment of the present invention, there is an automatic gain controlled circuit 230 disposed between the power detector 210 and the low noise amplifier 102. The power detector 210 will transmit the power level to the automatic gain controlled circuit 230 first and then the automatic gain controlled circuit 230 will transmit the signal to the low noise amplifier 102. Therefore, the low noise amplifier 102 can be operated in better power operation mode. In addition, the power manage device 220 is also able to connect with low noise amplifier 102, the first poly-phase filer 105, the complex mixer 114 and any other components (not shown), as shown in FIG. 4. Therefore, when the power manage device 220 received the power level detected by the power detector 210, the power manage device 220 will adjust the current of the low noise amplifier 102 in accordance with the current power level. And also the first poly-phase filter 105, the complex mixer 114 and other components will be adjusted by the power manage device 220 at the same time, and those components can work compatibly with the low noise amplifier 102. Moreover, in the same period, the power manage device 220 can control the gain of the low noise amplifier 102 in accordance with the frequency of the local oscillator 110a to avoid the gain signal is big enough to be flowed to the mixer 106 or the local oscillator 110a. It would cause the problem of the frequency-shifted. Obviously, according to the operation of the power detector 210 and the power manage device 220 in the power manage module; the tuner 200 of the present invention can work in optimum power consumption and the optimum condition when the power level is too large.

When the input power level is a small signal, such as less than 10 dbm, the power manage device 220 will set the tuner in the minimum current mode control and output a current controlled signal, such as the largest gain of the current controlled signal, to the low noise amplifier 102. Similarly, in the preferred embodiment, there is an automatic gain controlled circuit 230 that disposed between the power detector 210 and the low noise amplifier 102. The power detector 210 will transmit the power level to the automatic gain controlled circuit 230 first and then the automatic gain controlled circuit 230 will transmit the signal to the low noise amplifier 102. Therefore, the low noise amplifier 102 can be operated in better power operation mode. Similarly, the power manage device 220 is also able to connect with low noise amplifier 102, the first poly-phase filter 105, the complex mixer 114 and any other components (not shown). Therefore, when the power manage device 220 received the power level detected by the power detector 210, the power manage device 220 will adjust the current of the low noise amplifier 102, the first poly-phase filter 105 and the complex mixer 106 in accordance with the current power level. And also other components will be adjusted by the power manage device 220 at the same time, and those components can work compatibly with the low noise amplifier 102. Obviously, according to the operation of the power detector 210 and the power manage device 220 in the power manage module; the tuner 200 of the present invention can work in optimum power consumption and the optimum condition when the power level is small.

When the input power level is between 50 dbm and 10 dbm, such as 30 dbm, the power detector 210 will not change the gain of the low noise amplifier 102. The low noise amplifier 102 is operated in the normal standard mode, such as the gain is configured in a linear operative range. The power manage device 220 is able to adjust the current of the low noise amplifier 102, the poly-phase filter 105 and the complex mixer 114 in accordance with the current power level. And also other components will be adjusted by the power manage device 220 at the same time, and those components can work compatibly with the low noise amplifier 102. The tuner 200 of the present invention can work in optimum power consumption and the optimum condition.

The low noise amplifier 102 will amplify the radio frequency with the power level in accordance with the controlled signal transmitted from the automatic gain controlled device 230 and the frequency is divided into I path and Q path by the RF poly-phase filter 105. The signals are respectively transmitted into the complex filter 114 (also called dual quadrature mixer). The complex mixer 114 is made by a plurality of mixer 106. The quadrature LO 111 will transmit the oscillated signal to the complex filter 114 to be mixed into I path and Q path's quadrature low IF signal. Another filter IF poly-phase filter 113 will converse the quadrature low IF signal into low IF signal in I Path and Q path.

Obviously, the basic structures in FIG. 2 and FIG. 4 are the similar. The different in FIG. 2 and FIG. 4 is that the change of the filter and the mixer. The quadrature LO 111 is used to generate the quadrature phase by a phase divided circuit 115 and the local oscillator 110 (such as divided by 2).

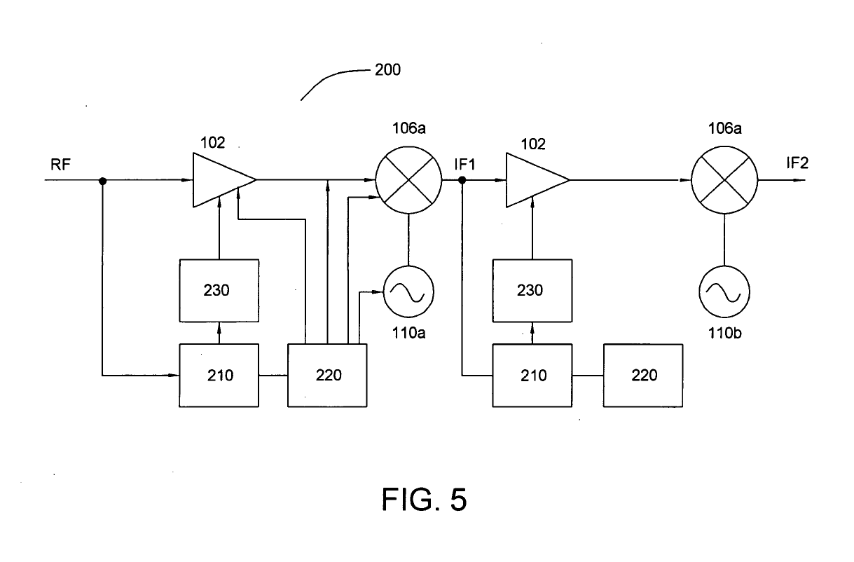

Now, FIG. 5 is a view showing a dual conversion tuner. The dual conversion tuner is made by two signal conversion units serially connected to each other. The pre-stage circuit includes a low noise amplifier 102, a radio/intermediate frequency mixer 106b, a local oscillator 10a and a power manage module. The post-stage circuit includes a low noise amplifier 102, an intermediate/intermediate mixer 106a, a local oscillator 110b and a power manage module. In the present embodiment, the power manage module includes a power detector 210 and a power manage device 220. There is also an automatic gain controlled circuit 230 disposed between the power detector 210 and the low noise amplifier 102. In addition, the single conversion unit in the pre-stage circuit is able to form an up-conversion unit by the local oscillator 110a, as the oscillated frequency of the local oscillator is 1 GHz˜2 GHz. The signal conversion unit in post-stage is able to form a down-conversion unit by the local oscillator 110b, as the oscillated frequency of the local oscillator is 1 GHz.

Because the dual conversion tuner is made by two single conversion unit serially connected to each other, the operation in each one of the single conversion unit and the power manage module is the same as the embodiments shown in FIG. 2, FIG. 3 and FIG. 4. Therefore, the detail description of the dual conversion tuner is omitted. It should be noted that, in practical, only the single conversion unit (up-conversion unit) in pre-stage works with the power manage module but the single conversion unit (down-conversion unit) in post-stage doesn't not work with power manage module. Also, only the single conversion unit (down-conversion unit) in post-stage works with the power manage module but the single conversion unit (up-conversion unit) in pre-stage doesn't not work with power manage module. Those are embodiments in the present invention, it is not limited herein.

In addition, in order to let the tuner of the present invention in good performance mode, a low noise amplifier used to adjust automatically the input impedance in accordance with the input radio signal is provided in the present invention. The detail description is in the following.

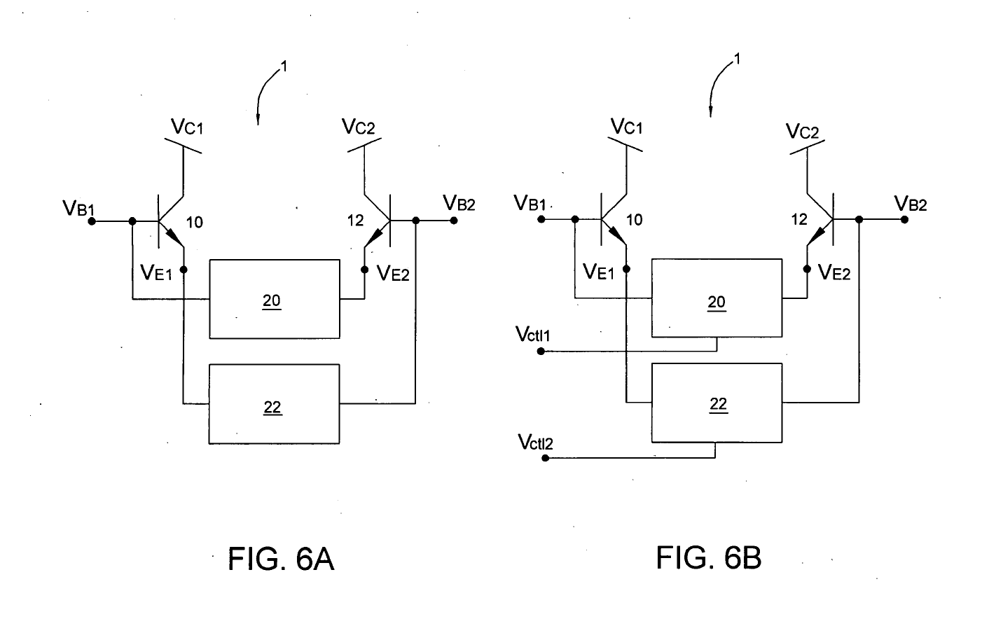

FIG. 6A is a view showing the low noise amplifier of the present invention. The low noise amplifier 1 includes a first active component 10, a second active component 12 and a plurality of adjustable attenuation device 20, 22. Each one of the active component in the low noise amplifier 1 includes a first end, a second end and a third end. In the present embodiment, the active components are BJT and the first end is a base end, the second end is the emitter end and the third end is a collector end. Besides, the adjustable attenuation devices 20, 22 are components with two ends, such as resistance, inductance, capacitance, diode and any combination above. The adjustable attenuation devices can be the component with three ends, such as BJT, FET, MOSFET or CMOS.

Please still referring to FIG. 6A, the base ends of the first active component 10 and the second active component 12 are connected to the input end and used to receive the broadband radio frequency fed from the antenna of the tuner. When the first adjustable attenuation device 20 is a two ends component, the first end is connected to the base end of the first active component 10 and the second end is connected to the emitter end of the second active component 12. Besides, the second adjustable attenuation device 22 is a two ends component too, the first end is connected to the base end of the first active component 10 and the second end is connected to the emitter end of the second active component 12. Obviously, the voltage (V_{B1}) of the base end of the first active component 10 and the voltage V_{E2} of the emitter end of the second active component 12 can be adjusted or changed to change the impedance of the adjustable attenuation device 20. The voltage (V_{E1}) of the emitter end of the first active component 10 and the voltage V_{B2} of the base end of the second active component 12 can be adjusted or changed to change the impedance of the adjustable attenuation device 22. therefore, when the gains of the first active component 10 and the second active component 12 in the low noise amplifier of the present invention are adjusted, such as adjusting the gain o f the low noise amplifier by a power manage device, the input impedance of the low noise amplifier 1 is changeable in a small range, for example the input impedance is changeable within 50±2Ω. Therefore, the tuner and the low noise amplifier can maintain in the optimum compatible impedance condition. Certainly, before the input signal is transmitted from the antenna of the tuner to the low noise amplifier 1, the input signal is optionally transmitted to amplifier circuit (not shown), such as an automatic gain controlled circuit.

Besides, in order to adjust the input impedance, the adjustable attenuation device 20 and 22 can be the adjustable component, such as adjustable resistance, adjustable inductance, adjustable capacitance and so on. The third end (such as collector end) of the first active component 10 and the second active component 12 is connected to the two ends component (not shown) to be the load of the low noise amplifier 1. The two ends component is resistance, inductance, capacitance, diode or any combinations above.

Now referring to FIG. 6B, FIG. 6B is a view showing another embodiment of the low noise amplifier in the present invention. The base ends of the first active component 10 and the second active component 12 are connected to the input end and used to receive the broadband radio frequency fed from the antenna of the tuner. When the first adjustable attenuation device 20 is a three ends component, such as a BJT, the third end (such as collector) is connected to the base end of the second active component 12 and the second end (such as emitter) is connected to the emitter of the first active component 10 and the first end (such as base) is connected to a voltage control end V_{ctl2} used to adjust voltage. Obviously, the voltage (V_{B1}) of the base end of the first active component 10 and the voltage V_{E2} of the emitter end of the second active component 12 are adjusted or changed to adjust the voltage V_{ctl1} of the voltage controlled end of the adjustable attenuation device 20 to change the impedance of the adjustable attenuation device 20. Similarly, the voltage (V_{B2}) of the base end of the second active component 12 and the voltage V_{E1} of the emitter end of the first active component 10 are adjusted or changed to adjust the voltage V_{ctl1} of the voltage controlled end of the adjustable attenuation device 20 to change the impedance of the adjustable attenuation device 20. Therefore, when the gains of the first active component and the second active component in the low noise amplifier of the present invention are adjusted, such as adjusting the gain of the low noise amplifier by a power manage device, the input impedance of the low noise amplifier 1 is changeable in a small range, for example the input impedance is changeable within the 75±5Ω. Therefore, the tuner and the low noise amplifier can maintain in the optimum compatible impedance condition. Certainly, before the input signal is transmitted from the antenna of the tuner to the low noise amplifier 1, the input signal is optionally transmitted to amplifier circuit (not shown), such as an automatic gain controlled circuit.

Besides, in order to adjust the input impedance, the adjustable attenuation device 20 and 22 can be BJT, FET, MOSFET or CMOS. In the preferred embodiment, the voltage value of the voltage controlled end (V_{ctl1}, V_{ctl2}) can be chosen to be zero voltage. The third end (such as collector end) of the first active component 10 and the second active component 12 is connected to the two ends component (not shown) to be the load of the low noise amplifier 1. The two ends component is resistance, inductance, capacitance, diode or any combinations above.

Besides, the first adjustable attenuation device 20 and 22 shown in FIG. 6A and FIG. 6B of the present invention can be a plurality of components being parallel to each other. In other words, the first adjustable attenuation device 20 and the second adjustable attenuation device 22 can be formed by a plurality of adjustable attenuation devices being parallel connection.

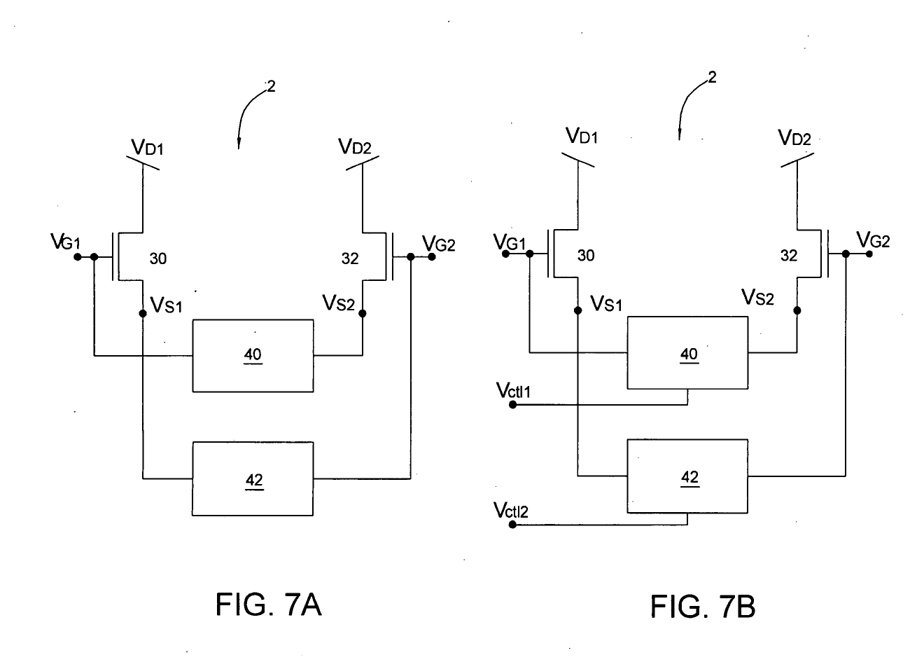

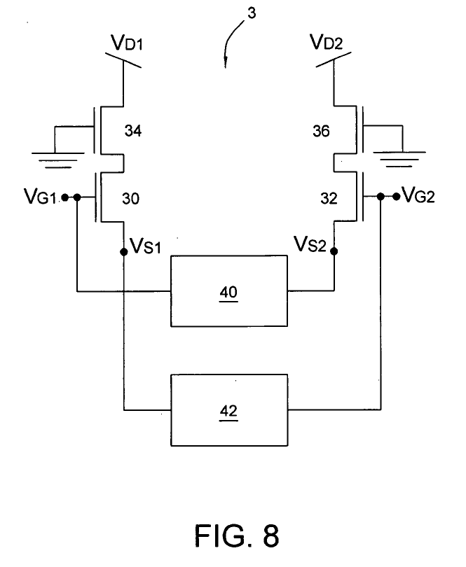

FIG. 7A is a view showing the low noise amplifier in another embodiment of the present invention. As shown in FIG. 7A, the low noise amplifier 2 includes a first active component 30, a second active component 32 and a plurality of adjustable attenuation device 40, 42. The active components 30 and 32 are FET, MOSFET, CMOS and so on. The first end is a gate end, the second end is the source end and the third end is a drain end. Besides, the adjustable attenuation devices 40, 42 are components with two ends, such as resistance, inductance, capacitance, diode and any combination above. Besides, the adjustable attenuation devices 40, 42 are components with three ends, such as BJT, FET, MOSFET, CMOS and so on.

Obviously, the circuit structure in FIG. 7A is the same as the structure shown in FIG. 6A and FIG. 6B. The first active component is replaced from BJT to FET, MOSFET or CMOS. In the present embodiment, the NMOS is chosen to be the active component.

Please still referring to FIG. 7A, the gate ends of the first active component 30 and the second active component 32 are connected to the input end and used to receive the broadband radio frequency fed from the antenna of the tuner. When the first adjustable attenuation device 40 is a two ends component, the first end is connected to the gate end (V_{G1}) of the first active component 30 and the second end is connected to the source end (V_{S2}) of the second active component 32. Besides, as the second adjustable attenuation device 42 is a two ends component too, the first end is connected to the gate end (V_{G2}) of the second active component 32 and the second end is connected to the source end (V_{S2}) of the first active component 30. Obviously, when the gain of the low noise amplifier in the present invention is adjusted (such as a power manage module used to adjust the gain of the low noise amplifier), the input impedance of the low noise amplifier 2 can be adjusted within a small range, such as the impedance is within 50±2Ω, by the connection of the first adjustable attenuation device 40 and the second adjustable attenuation device 42. Therefore, the tuner and the low noise amplifier can maintain in the optimum compatible impedance condition. Certainly, before the input signal is transmitted from the antenna of the tuner to the low noise amplifier 2, the input signal is optionally transmitted to amplifier circuit (not shown), such as an automatic gain controlled circuit.

Moreover, in order to adjust the input impedance, the adjustable attenuation device 40 and 42 can be the adjustable component, such as adjustable resistance, adjustable inductance, and adjustable capacitance and so on. The third ends (such as drain ends) of the first active component 30 and the second active component 32 are connected to the two ends component (not shown) to be the load of the low noise amplifier 2. The two ends component is resistance, inductance, capacitance, diode or any combinations above.

Now referring to FIG. 7B, which is a view showing another embodiment of the low noise amplifier in the present invention. The gate ends of the first active component 30 and the second active component 32 in the low noise amplifier 2 are connected to the input end and used to receive the broadband radio frequency fed from the antenna of the tuner. When the first adjustable attenuation device 40 is a three ends component, such as a NMOS, the third end (such as drain end) is connected to the gate end (V_{G1}) of the first active component 30 and the second end (such as source end) is connected to the source end (V_{S2}) of the second active component 32 and the first end (such as gate end) is connected to a voltage control end Vctl1 used to adjust voltage. Besides, when the second adjustable attenuation device 42 is a three ends component (such as a NMOS), the third end (such as drain end) is connected to the gate end (V_{G2}) of the second active component 32 and the second end (such as source end) is connected to the source end (V_{S1}) of the first active component 30 and the first end (such as gate end) is connected to a voltage control end V_{ctl2} used to adjust voltage.

Obviously, the voltage (V_{G1}) of the gate end of the first active component 30 and the voltage V_{S2} of the source end of the second active component 12 are adjusted or changed to be a fixed voltage value and the voltage of the voltage controlled end V_{ctl1} of the first adjustable attenuation device 40 is changed to a suitable voltage value, then the impedance of the adjustable attenuation device 20 is adjustable. Similarly, the voltage (V_{S1}) of the source end of the first active component 30 and the voltage (V_{G2}) of the gate end of the second active component 32 are adjusted or changed and the voltage of the voltage controlled end V_{ctl2} of the adjustable attenuation device 42 is adjusted, then the impedance of the adjustable attenuation device 42 is adjustable. Therefore, according to the connection of the adjustable attenuation device 40 or 42, the input impedance of the low noise amplifier 2 is changeable in a small range, for example the input impedance is changeable within the 75±5Ω. Therefore, the tuner and the low noise amplifier can maintain in the optimum compatible impedance condition. Certainly, before the input signal is transmitted from the antenna of the tuner to the low noise amplifier 2, the input signal is optionally transmitted to amplifier circuit (not shown), such as and automatic gain controlled circuit.

Besides, in order to adjust the input impedance, the adjustable attenuation device 40 and 42 can be BJT, FET, MOSFET or CMOS. In the preferred embodiment, the voltage value of the voltage controlled end V_{ctl1}, V_{ctl2}) can be chosen to be zero voltage. The third ends (such as drain ends) of the first active component 30 and the second active component 32 are connected to the two ends component (not shown) to be the load of the low noise amplifier 2. The two ends component is resistance, inductance, capacitance, diode or any combinations above.

In addition, the first adjustable attenuation device 40 and 42 as shown in FIG. 7A and FIG. 7B of the present invention can be a plurality of components being parallel to each other. In other words, the first adjustable attenuation device 40 and the second adjustable attenuation device 42 can be formed by a plurality of adjustable attenuation devices being parallel connection.

FIG. 8 is a view showing another embodiment of the low noise amplifier in the present invention. As shown in FIG. 8, the low noise amplifier 3 includes a first active component 30, a second active component 32, a third active component 34, a forth active component 36 and a plurality of adjust attenuation device 40 and 42. The adjustable attenuation devices can be BJT, FET, MOSFET or CMOS. The first end is a gate end, the second end is the source end and the third end is a drain end. Besides, the adjustable attenuation devices 40, 42 are components with two ends, such as resistance, inductance, capacitance, diode and any combination above. Besides, the adjustable attenuation devices 40, 42 are components with three ends, such as BJT, FET, MOSFET, CMOS and so on.

Obviously, the circuit structure of the embodiment shown in FIG. 8 is the same as the circuit shown in FIG. 7A and FIG. 7B. In FIG. 8, the active components 34 and 36 are respectively connected to the active components 30 and 32 shown in FIG. 7A and FIG. 7B. The third end (drain) of the active component 30 is connected to the second end (source) of the active component 34. Besides, the third end (drain) of the active component 34 is connected to a load device and the first end (gate) of the active component 34 is connected to the ground. The object to add an active component 34 and an active component 36 is to increase the output impedance of the low noise amplifier.

Obviously, the circuit structure in FIG. 8 is the same as the structure shown in FIG. 6A and FIG. 6B. The active components 10 and 12 are connected to an active component. The active component is a BJT, FET, MOSFET or CMOS. Because the circuit structure and the operated procedure are similar to the description above, the detail description is omitted herein.

Obviously, the low noise amplifier in FIG. 6 to FIG. 8 is a low noise amplifier able to automatically adjust the input impedance in accordance with the radio frequency. The low noise amplifier can replace the low noise amplifier in FIG. 2, FIG. 3, FIG. 4, and FIG. 5. Moreover, it should be noted that because the improvement of the semiconductor manufacture technique, so the tuner, the low noise amplifier, the mixer, the oscillator power detector, power/current controlled device and the automatic gain controlled device is above to be made with a die and formed a tuner with system on chip.

Although specific embodiments have been illustrated and described, it will be appreciated by those skilled in the art that various modifications may be made without departing from the scope of the present invention, which is intended to be limited solely by the appended claims.

What is claimed is:

1. A frequency conversion device comprising at least one low noise amplifier, a mixer, a local oscillator and a power manage module is characterized at:
the power manage module comprising:
a power detector and a first end of the power detector is connected to the input end of the frequency conversion device and used to detect the power level of the input end, and the second end is connected to the low noise amplifier; and
a power manage device and a first end of the power manage device is connected to the low noise amplifier.

2. The frequency conversion device of claim 1, further comprising an automatic gain controlled circuit disposed between the power detector and the low noise amplifier.

3. The frequency conversion device of claim 1, wherein the power manage device is a power/current mode controlled device.

4. The frequency conversion device of claim 1, wherein the frequency received in the input end is a radio frequency.

5. The frequency conversion device of claim 1, wherein the frequency received in the input end is an intermediate frequency.

6. The frequency conversion device of claim 1, wherein the low noise amplifier comprises:
a first active component having a first end, a second end and a third end, and wherein the first end is connected to the input end of the frequency conversion device;
a second active component having a first end, a second end and a third end, and wherein the first end is connected to the another input end of the frequency conversion device;
a first adjustable attenuation device, and a first end of the first adjustable attenuation device is connected to the first end of the first active component and a second end is connected to the second end of the second active component; and
a second adjustable attenuation device, and a first end of the first adjustable attenuation device is connected to the second end of the first active component and a second end is connected to the first end of the second active component.

7. The frequency conversion device of claim 1, wherein the first active component and the second active component of the low noise amplifier are selected from the group consisting of: BJT, FET, MOS and CMOS.

8. The frequency conversion device of claim 6, wherein the first adjustable attenuation device and the second adjustable attenuation of the low noise amplifier are selected form the group consisting of: resistance, inductance, capacitor, diode and combination thereof.

9. The frequency conversion device of claim 6, wherein the first adjustable attenuation device and the second adjustable attenuation of the low noise amplifier are three ends active components.

10. The frequency conversion device of claim 9, wherein the three end component is selected from the group consisting of: BJT, FET and MOS.

11. The frequency conversion device of claim 6, wherein at least one of the first adjustable attenuation devices is parallel connection with at least one of the second adjustable attenuation devices.

12. A dual frequency conversion device comprising a serial connection of a first single frequency conversion device and a second single frequency conversion device and the first single frequency conversion device and the second single frequency conversion device includes a low noise amplifier, a mixer, an oscillator and a power manage module and is characterized by:
the power manage module comprising:
a power detector and a first end of the power detector is connected to the input end of the frequency conversion device and used to detect the power level of the input end, and the second end is connected to the low noise amplifier; and
a power manage device and a first end of the power manage device is connected to the low noise amplifier.

13. The dual frequency conversion device of claim 12, wherein a second end of the power manage device of the first single frequency conversion device is connected to the low noise amplifier.

14. The dual frequency conversion device of claim 12, wherein a third end of the power manage device of the first single frequency conversion device is connected to the mixer.

15. The dual frequency conversion device of claim 12, wherein the first single frequency conversion device further comprising an automatic gain controlled circuit disposed between the power detector and the low noise amplifier.

16. The dual frequency conversion device of claim 12, wherein the second single frequency conversion device further comprises an automatic gain controlled circuit disposed between the power detector and the low noise amplifier.

17. The dual frequency conversion device of claim 12, wherein the power manage device is a power/current mode controlled device.

18. The dual frequency conversion device of claim 12, wherein the low noise amplifier of the first single conversion device comprises:
a first active component including a first end, a second end and a third end, and wherein the first end is connected to the input end of the frequency conversion device;
a second active component including a first end, a second end and a third end, and wherein the first end is connected to the another input end of the frequency conversion device;
a first adjustable attenuation device, and a first end of the first adjustable attenuation device is connected to the first end of the first active component and a second end is connected to the second end of the second active component; and
a second adjustable attenuation device, and a first end of the first adjustable attenuation device is connected to the second end of the first active component and a second end is connected to the first end of the second active component.

19. The dual frequency conversion device of claim 18, wherein at least one of the first adjustable attenuation devices is parallel connection with at least one of the second adjustable attenuation devices.

20. The dual frequency conversion device of claim 12, wherein the low noise amplifier of the second single conversion device comprises:
a first active component including a first end, a second end and a third end, and wherein the first end is connected to the input end of the frequency conversion device;
a second active component including a first end, a second end and a third end, and wherein the first end is connected to the another input end of the frequency conversion device; and
a first adjustable attenuation device, and a first end of the first adjustable attenuation device is connected to the first end of the first active component and a second end is connected to the second end of the second active component; and a second adjustable attenuation device, and a first end of the first adjustable attenuation device is connected to the second end of the first active component and a second end is connected to the first end of the second active component.

21. The dual frequency conversion device of claim 20, wherein at least one of the first adjustable attenuation devices is parallel connection with at least one of the second adjustable attenuation devices.

22. A tuner comprising a filter, a low noise amplifier, a mixer, a local oscillator, a frequency selector, and a power manage module is characterized by:
the power manage module comprising:
a power detector and a first end of the power detector is connected to the input end of the frequency conversion device and used to detect the power level of the input end, and the second end is connected to the low noise amplifier; and
a power manage device and a first end of the power manage device is connected to the low noise amplifier.

23. The tuner of claim 22, wherein a second end of the power manage device is connected to the low noise amplifier.

24. The tuner of claim 22, wherein a third end of the power manage device is connected to the mixer.

25. The tuner of claim 22, wherein further includes an automatic gain controlled circuit disposed between the power detector and the low noise amplifier.

26. The tuner of claim 22, wherein the power manage device is a power/current mode controlled device.

27. A tuner comprising a poly-phase filter, a low noise amplifier, a complex mixer, a quadrature local oscillator, a frequency selector and a power manage module is characterized by:
the power manage module comprising:
a power detector and a first end of the power detector is connected to the input end of the frequency conversion device and used to detect the power level of the input end, and the second end is connected to the low noise amplifier; and
a power manage device and a first end of the power manage device is connected to the low noise amplifier.

28. The tuner of claim 27, wherein a second end of the power manage device is connected to the low noise amplifier.

29. The tuner of claim 27, wherein a third end of the power manage device is connected to the poly-phase mixer.

30. The tuner of claim 27, wherein a forth end of the power manage device is connected to the complex mixer.

31. The tuner of claim 27, wherein further includes an automatic gain controlled circuit disposed between the power detector and the low noise amplifier.

32. The tuner of claim 27, wherein the power manage device is a power/current mode controlled device.

33. A tuner having a serial connection of a first single frequency conversion device and a second single frequency conversion device, a filter, a low noise amplifier, and the first single frequency conversion device includes a mixer, a local oscillator, a frequency selector and a power manage module and the second single frequency conversion device includes a mixer, a local oscillator, a frequency selector and a power manage module and is characterized by:
the power manage module of the first single frequency conversion device comprising:
a power detector and a first end of the power detector is connected to the input end of the frequency conversion device and used to detect the power level of the input end, and the second end is connected to the low noise amplifier;
a power manage device and a first end of the power manage device is connected to the low noise amplifier; and
the power manage module of the second single frequency conversion device comprising:
a power detector and a first end of the power detector is connected to the input end of the frequency conversion device and used to detect the power level of the input end, and the second end is connected to the low noise amplifier; and
a power manage device and a first end of the power manage device is connected to the low noise amplifier.

34. A tuner comprising a serial connection of a first single frequency conversion device and a second single frequency conversion device, and the first single frequency conversion device comprises a filter, a low noise amplifier, a mixer, a local oscillator, a frequency selector and a power manage module and the second single frequency conversion device comprises a low noise amplifier, a mixer, a local oscillator, a frequency selector and a frequency selector and is characterized by: the power manage module comprising:
a power detector and a first end of the power detector is connected to the input end of the frequency conversion device and used to detect the power level of the input end, and the second end is connected to the low noise amplifier; and
a power manage device and a first end of the power manage device is connected to the low noise amplifier.

35. A tuner having a serial connection of a first single frequency conversion device and a second single frequency conversion device, and the first single frequency conversion device includes at least one filter, a low noise amplifier, a mixer, a local oscillator, and a frequency selector and the second single frequency conversion device includes at least one low noise amplifier, a mixer, a local oscillator, a frequency selector and a frequency selector and is characterized by:
the power manage module comprising:
a power detector and a first end of the power detector is connected to the input end of the frequency conversion device and used to detect the power level of the input end, and the second end is connected to the low noise amplifier; and
a power manage device and a first end of the power manage device is connected to the low noise amplifier.

36. A adjust method of a tuner, comprising:
providing a tuner and the tuner includes a filter, a low noise amplifier, a mixer, a local oscillator, a frequency selector and a power manage module;
executing a power detecting to receive a radio frequency of the tuner and detect a power level of the radio frequency by an input end of a power detector;
executing a power programming to determine the power level and output a controlled signal by a power manage device; and
executing a power adjusting to adjust the gain of the low noise amplifier by the controlled signal.
